(19) United States
(12) Patent Application Publication
(10) Pub. No.: US 2005/0133367 A1
(43) Pub. Date: Jun. 23, 2005

(54) Electrical urea biosensors and its manufacturing method

(76) Inventors: Shen Kan Hsiung, Chung-Li (TW); Jung Chuan Chou, Douliou City (TW); Tai Ping Sun, Jhongli City (TW); Jia-Chyi Chen, (US); Chung We Pan, Wandan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/739,159

(22) Filed: Dec. 19, 2003

(51) Int. Cl. G01N 27/26

(52) U.S. Cl. 204/403.1; 29/592.1

(57) ABSTRACT

The present invention is to provide an electrical urea biosensor and its manufacturing method. In the present invention, a sensitive film is positioned on a surface of a substrate, wherein a conductive layer is formed on the surface of the substrate. The sensitive film is used as an ion-sensitive electrode. The sensitive film provides with a sensitive region and a non-sensitive region. A conductive line is extended from the conductive layer for using as an external electrical contact point. The present invention utilizes a package encapsulant covering the non-sensitive region of the sensitive film to define a sensitive window at the sensitive region and a urea enzyme is immobilized within the sensitive window of the sensitive film. Then, the present invention completes the formulation of a urea biosensor. The present invention is a disposable urea biosensor and provides with advantages of the mass production, low cost, and the easy package.

### BACKGROUND OF THE INVENTION

1. Field of the Invention

The present invention generally relates to a electrical urea biosensor and its manufacturing method, and more particularly relates to a technology for forming a urea biosensor by using a pH sensitive film with a tin oxide used as the separative gate ion-sensitive field effect transistor (EGFET) and cooperating the use of the urea enzyme.

2. Description of the Prior Art

Accordingly, the urea concentration in the blood responses the assimilation and the dissimilation catabolism of the protein and simultaneously has a closely relation of the kidney function, the liver function, and the secretion of the adrenalin. Hence, the urea nitrogen concentration of the blood or the urine is an important health index of the human body and is also an important data of the kidney function in the clinical diagnosis.

However, the conventional quantitative analysis of the organic matter has many disadvantages in the practical use, such as the complicated operation, the long analysis time, and expensive equipments, and it cannot be used in the detection of the continuous process. Hence, in order to overcome the prior disadvantage of the prior quantitative analysis, a biosensor is developed and combined with the biochemistry technology, the electronic circuits, the materials science, and the optical theory so as to design the biosensor to conform to the requirement in each fields.

The ion-sensitive field effect transistor was presented at 1970 and rapidly developed to the microminiaturized sensor. The sensor provides with the ion-sensitive electrode function and also has the character of the field effect transistor and it is completely different from the conventional electrode. The sensor has the advantages of the microminiaturization, the easy instrumentation ability, and suitable for the automation design. Following, in 1980, Caras and Janata further disclosed the gate provided with an ion-sensitive field effect transistor immobilized the aspirin within for using as the aspirin biosensor, which was called the enzyme field effect transistor.

Currently, there are many patents proposed. For example, the U.S. Pat. No. 5,922,183 in titled of “Metal oxide matrix biosensor” disclosed a substrate provided with a thin film matrix for biomolecules belonging to a general class of materials known as hydrous metal oxides and provided an amperometric biosensor or a potentiometric biosensor to perform the sensing test by the enzymes, cofactors, antibodies, antigens and the series of the nucleic acids. The U.S. Pat. No. 5,858,186 in titled of “Urea biosensor for hemodialysis monitoring” disclosed an electrochemical sensor capable of detecting and quantifying urea in fluids resulting from hemodialysis procedures. The sensor is based upon measurement of the pH change produced in an aqueous environment by the products of the enzyme-catalyzed hydrolysis of urea. The U.S. Pat. No. 5,833,824 in titled of “Dorsal substrate guarded ISFET sensor” disclosed an Ion-sensitive Field Effect Transistor (ISFET) sensor for sensing ion activity of a solution. The U.S. Pat. No. 4,877,582 in titled of “Chemical sensor device with field effect transistor” disclosed a chemical sensor having a field-effect transistor as an electronic transducer and used for the analysis of specific constituents in a liquid, the chemical sensor comprising means which permits an externally supplied sample solution to reach a chemical receptor of said chemical sensor.

Owing to the biological technology is quiet extensive, the present invention is to provide a urea biosensor belong to the formulation of the semiconductor process technology in accordance with the urea concentration of the blood or the urine and the biosensor is to detect the pH value so as to develop a structure of a disposable sensor.

### SUMMARY OF THE INVENTION

The primary object of the present invention is to provide an electrical urea biosensor and its manufacturing method. The present invention utilizes a non-isolation solid-state ion-sensitive film to use as a sensitive electrode of an ion-sensitive gate field effect transistor and also utilizes the semiconductor process technology to manufacture a disposable urea biosensor.

Another object of the present invention is to provide an electrical urea biosensor and its manufacturing method. The present invention can be mass production and provides with the advantage of the low cost and the easy package so as can reduce the cost of the prior ion-sensitive gate field effect transistor simplify the package.

A further object of the present invention is to provide an electrical urea biosensor and its manufacturing method. The present invention provides with advantages of the simple production, the low cost, easily dry storage, the adjustable sensitive area, and the easy conveyance.

In order to achieve previous objects, one of the embodiments of the present invention is to provide a structure of an electrical urea biosensor. A sensitive film is positioned on a surface of a substrate, wherein a conductive layer is formed on the surface of the substrate. The sensitive film is used as an ion-sensitive electrode. The sensitive film provides with a sensitive region and a non-sensitive region. A conductive line is extended from the conductive layer for using as an external electrical contact point. The present invention utilizes a package encapsulant covering the non-sensitive region of the sensitive film to define a sensitive window at the sensitive region and a urea enzyme is immobilized within the sensitive window of the sensitive film. Then, the present invention can utilize the urea biosensor to detect of the urea concentration of the blood sample or the urine sample.

Another embodiment of the present invention is to provide a manufacturing method of an electrical urea biosensor. The manufacturing method comprises the following steps. First, a substrate is provided and a conductive layer is formed on a surface of the substrate. Then, a sensitive film is formed on a surface of the conductive layer of the substrate for using as an ion-sensitive electrode. Wherein, the sensitive film provides with a sensitive region and a non-sensitive region. Next, a conductive line is formed and extended from the conductive layer for using as an external electrical contact point. Following, a package step is performed by utilizing a package encapsulant to cover the non-sensitive region of the sensitive film so as to define a sensitive window at the sensitive region. Last, the present invention utilizes an enzyme-immobilized technology to immobilize a urea enzyme within the sensitive window of the sensitive film. Hence, the present invention completes a urea biosensor and utilizes the urea biosensor to perform the detection of the pH value so as to measure the urea concentration.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic representation of the structure of the cutaway view of the electrical urea biosensor, in accordance with the present invention;

FIG. 2a and FIG. 2d are schematic representations structures of the cutaway view at various stages during the formulation the electrical urea biosensor, in accordance with the present invention;

FIG. 3 is a schematic representation of the framework view of the measurement of the electrical urea biosensor, in accordance with the present invention;

FIG. 4 is a schematic representation of the correction curve view of the pH value of the electrical urea biosensor, in accordance with the present invention;

FIG. 5 is a schematic representation of the status view of the response time and the return time of the electrical urea biosensor, in accordance with the present invention;

FIG. 6 is a schematic representation of the correction curve view of the pH value of the electrical urea biosensor at the measurement environment with various pH values, in accordance with the present invention;

FIG. 7 is a schematic representation of the correction curve view of the pH value of the electrical urea biosensor as buffer solutions with various concentrations, in accordance with the present invention; and

FIG. 8 is a schematic representation of the maximum variation of the responsible voltage of the electrical urea biosensor as the time increasing, in accordance with the present invention.

### DESCRIPTION OF THE PREFERRED EMBODIMENT

The present invention utilizes the tin dioxide as the pH ion-sensitive film of the extended ion-sensitive gate field effect transistor (EGFET) and utilizes the separation structure of tin dioxide/indium tin oxide/substrate to form the urea biosensor. All the structure is the separative gate ion-sensitive field effect transistor and the suitable range of the structure is all biosensor based on the pH value detecting.

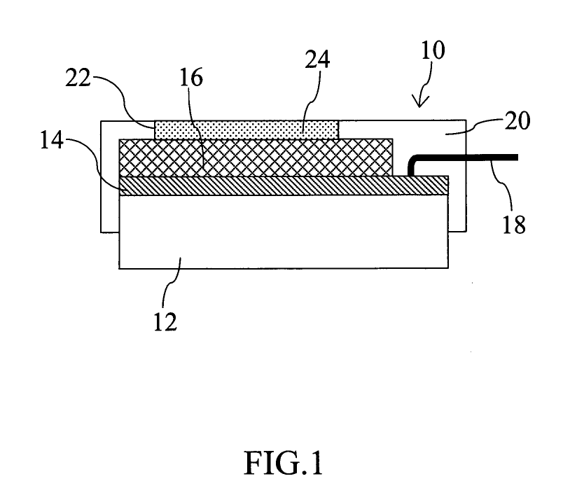

Such as shown in the FIG. 1, the present invention is an electrical urea biosensor comprising a glass substrate 12, wherein an indium tin oxide (ITO) conductive layer 14 on a surface of the glass substrate 12. Besides, there is a non-isolation solid state ion-sensitive film 16, such as the solid material of the tin dioxide, positioned on a surface of the indium tin oxide conductive layer 14 to use as the solid state ion-sensitive electrode to detect the pH value of the solution. The ion-sensitive film 16 provides with a sensitive region and a non-sensitive region. Then, a conductive line 18 is utilized to extend from the indium tin oxide conductive layer 14 for using as an external electrical contact point. A package encapsulant is used to cover the non-sensitive region of the ion-sensitive film 16 and to define a sensitive window 22. The present invention utilizes the package encapsulant 20 to define the sensitive area of the biosensor, wherein the sensitive area is about 2² mm². A urea enzyme 24 is immobilized in the sensitive window 22 of the ion-sensitive film 16, wherein the urea enzyme 24 is composed of urease, which is embedded by a PVA-SbQ encapsulant. The present urea biosensor 10 is more easily than the prior ion-sensitive field effect transistor on the formulation and the package can reduce the cost to conform to the requirement of the disposable biosensor.

Wherein, the embodiment of the electrical urea biosensor mentioned above is using the glass substrate as its biosensor substrate. Besides, the substrate can be also selected from the group of an isolation substrate and a non-isolation substrate. Furthermore, the isolation substrate can be selected from the group of a silicon substrate, a glass substrate, a ceramics substrate, and a polymer substrate. Hence, the present biosensor has a better variation of the substrate and can change the substrate material depending on the different practical use and process condition.

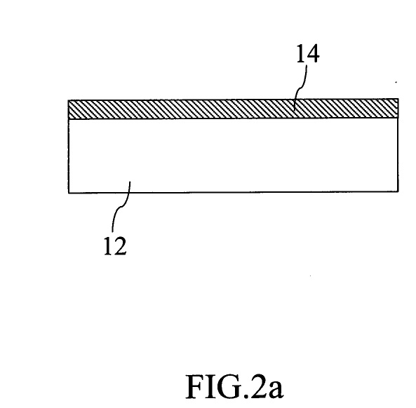

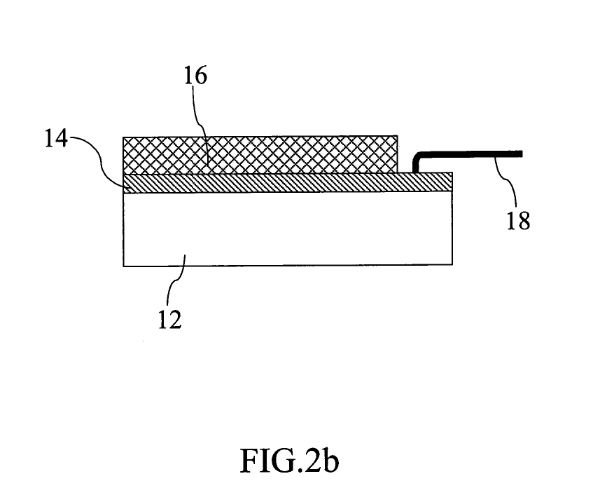

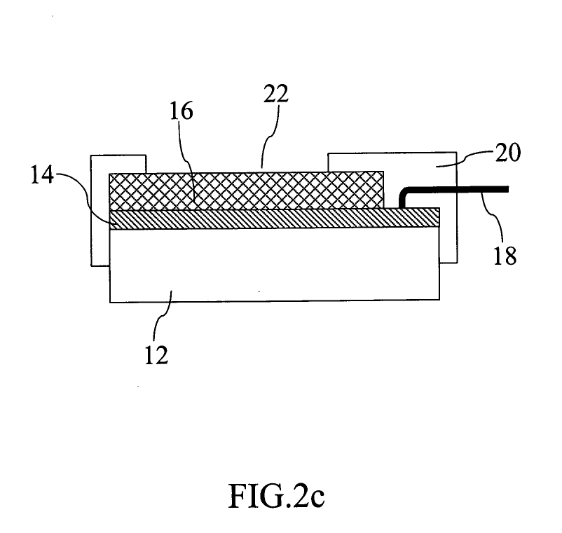

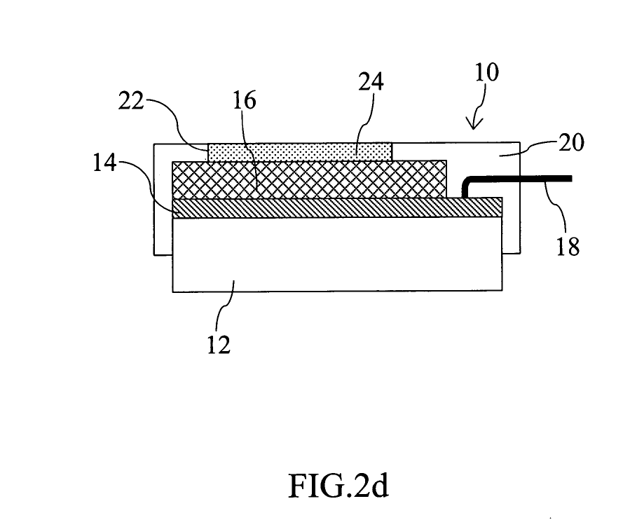

Now, in order to illustrate the manufacturing method of the present invention in accordance with the structure of the FIG. 1 shown mentioned above, referring to the FIG. 2a to the FIG. 2d, there are schematic representations structures at various stages to illustrate the formulation of the electrical urea biosensor in accordance with the embodiment of the present invention. The manufacturing method of the present invention comprises following steps:

First, referring to the FIG. 2a, a glass substrate 12 is provided and an indium tin oxide conductive layer 14 is formed thereon. The thickness of the indium tin oxide conductive layer 14 is about 230 angstroms and its electric resistance is about 50 ohm to 100 ohm.

Following, such as shown in the FIG. 2c, a sensitive film grown a tin dioxide sensitive film 16 on the surface of the indium tin oxide conductive layer 14 of the glass substrate 12 by using the sputtering method. The step uses the tin dioxide as the sputtering target and fills in the mixture gas of the argon (Ar) and the oxygen (O₂) at the ratio of 4:1. As the growing of the tin dioxide sensitive film 16, the temperature of the glass substrate 12 is maintained at 150° C., the depositing pressure is maintained at 20 milli-torr, the radio frequency (RF) power is maintained at 50 watt so as to form the film 16 with a thickness of 2000 angstroms and to use as the solid state ion-sensitive electrode. Wherein, the sensitive film 16 can be dividing into a sensitive region and a non-sensitive region. Then, a conductive line 18 is positioned to extend from the indium tin oxide conductive layer 14 for using as an external electrical contact point.

Referring to the FIG. 2c again, performing a package step, a package encapsulant, such as the epoxy, is used to cover the non-sensitive region of the ion-sensitive film 16 and a portion of the package encapsulant so as to define a sensitive window 22 of the sensitive region.

A package encapsulant is used to cover the non-sensitive region of the ion-sensitive film 16 and to define a sensitive window 22. The present invention utilizes the package encapsulant 20 to define the sensitive area of the biosensor, wherein the sensitive area is about 2² mm². A urea enzyme 24 is immobilized in the sensitive window 22 of the ion-sensitive film 16, wherein the urea enzyme 24 is composed of urease, which is embedded by a PVA-SbQ encapsulant.

Last, such as shown in the FIG. 2d, the present invention utilizes the enzyme immobilized technology to immobilize a urea enzyme 24 on the sensitive film 16 within the sensitive window 22. Herein, the present invention utilizes the characteristic of photo-polymerization of the photopolymer to immobilize the urea enzyme 24 on the sensitive window 22 and acts to complete the formulation of the urea biosensor 10. Besides, the present invention can also use other immobilized technology to form the electrical type electrochemistry biosensor. The present invention can reduce the instrument cost, such as the large-size optics biology analysis instrument, and can improve the portable characteristic of the biosensor. The present invention can use for the formulation of the promptly detecting sensor or the disposable sensor.

The detail illustration of the enzyme-immobilized technology is referenced to the following description:

First, a urease (urease, EC 3.5.1.5, 50000˜100000 units/g); a PVA-SbQ encapsulant (PVA, D.P.=1700, D.S.=88; SbQ, 1.52 mol %; N.V.=12.69 wt %; and the viscosity is about 5750 cp at 25° C.); the urea (NH₂CONH₂=60.06), wherein its degree of purity is 99%; and the phosphate (KH₂PO₄=136.09), which is the normal ACS grade and used for preparing the buffer solution, are prepared.

Following, the diluted PVA-SbQ (100 mg PVA-SbQ/100 ml-55 millimole phosphate solution of the pH value 7.0) and the urea solution (7 mg urea/100 ml-millimole phosphate solution of the pH value 7.0) are mixed at the ratio of 1:1. Next, 1 ml mixture solution is taken to drop on the sensitive window 22 and then the biosensor 10 is put under the illumination of the ultraviolet of 4 watt and 365 nm to perform the photo-polymerization with about 20 minutes. Last, after finishing the photo-polymerization, the biosensor 10 is put in a dark box of 4° C. with about 12 hours to complete the enzyme immobilized process.

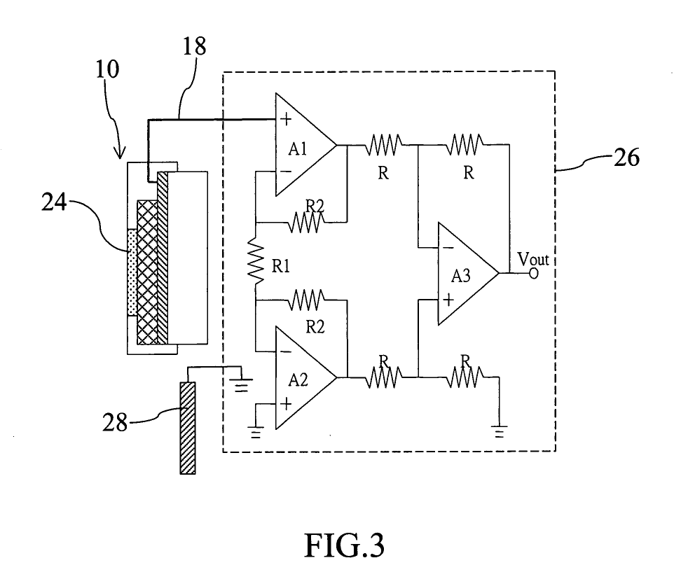

Such as shown in the FIG. 3, the present invention utilizes an electrical urea biosensor 10 of the separation structure of tin dioxide/indium tin oxide/glass substrate as a transducer. The biosensor utilizes the conductive line 18 to electrically connect to the potentiometer of the high input impedance, such as the metal-oxide-semiconductor field effect transistor and the operational amplifier. As shown in the Figure, the read out circuit is the LT1167 instrumentation amplifier 26 and co-operate with the silver/silver chloride electrode 28 to provide a reference stable potential so as to measure the response potential of the urea biosensor 10 in the solution to calculate the concentration of the solution.

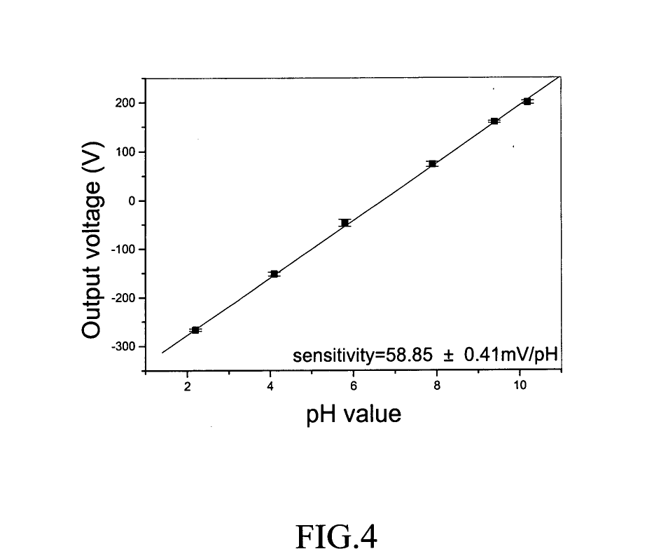

Referring to the FIG. 4, it is the correction curve view of the pH value of the electrical urea biosensor of the present invention. Such as shown in the figure, it is the pH sensitive characteristics of the tin dioxide sensitive film to make sure that the sensitivity of each batch sensor are in a stable range so as to use the mentioned instrumentation amplifier 26 to read out the different response potential of the sensor under the different pH environment. Where, as the pH value is between 2.2 to 10.2, the sensitivity of the tin dioxide sensitive film is about 58.85±0.41 millivoltage/pH value.

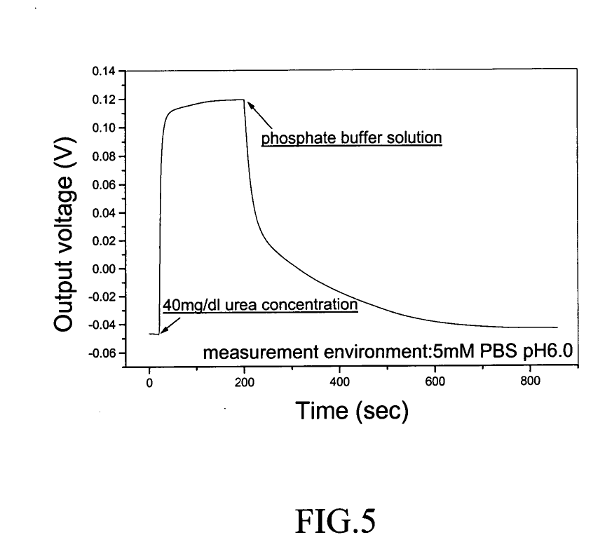

Referring to the FIG. 5, it is the status view of the response time and the return time of the electrical urea biosensor of the present invention. As shown in the figure, it presents the required response time and the required return time of the urea biosensor. According to the experiment result, after about 60 seconds, the response of the sensor is achieving the 90% degree of the maximum response potential and then the sensor is put into the buffer solution of 5 milli-mole. After 10 minutes, the response potential will slowly return to the potential before the reaction. Owing to the purpose of the extend biosensor structure is to develop the disposable biosensor, so the long or short response time is important to the disposable sensor, but not the necessary considering parameter.

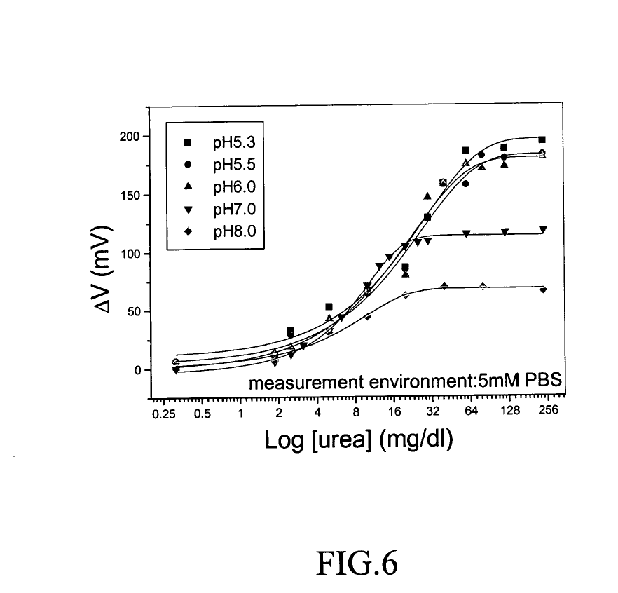

Referring to the FIG. 6, it is the correction curve view of the pH value of the electrical urea biosensor at the measurement environment with various pH values in accordance with the present invention and it presents the influence on the response potential and correction curve when the initial pH value of the pre-measured solution is changing. When the initial pH value is higher, the response changeable range is obviously decreasing and the maximum chance limitation of the urea hydrolysis reaction is the pH value 9.3. Hence, if the initial pH value of the pre-measured solution is too high, it will decrease the response changeable range. On the other hand, if the initial pH value of the pre-measured solution is lower, the response potential will become very small. According to the experiment result, how to find the balance point between both is that the pH value 6.0 is the best reaction environment.

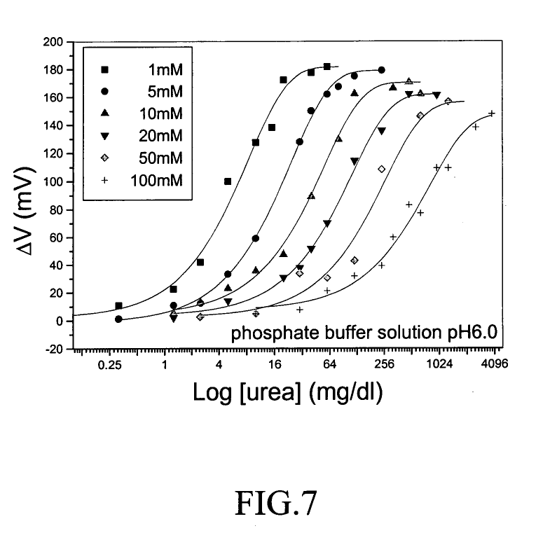

Such as shown in the FIG. 7, it is the correction curve view of the pH value of the electrical urea biosensor as buffer solutions with various concentrations in accordance with the present invention and it presents the influence causing from the different concentration of the buffer solution. Hence, the sensor based on the pH-sensitive is easily influenced from the buffer ability of the buffer solution and the concentration relation of the buffer solution is related with the strong or weak buffer solution ability. If the buffer concentration is higher, the buffer ability is more excellent. On the other hand, if the buffer concentration is lower, the buffer ability is more poor so as the pH difference generated near the sensitive window will immediately response on the potential difference and the correction curve will slant move to the direction of the low urea concentration.

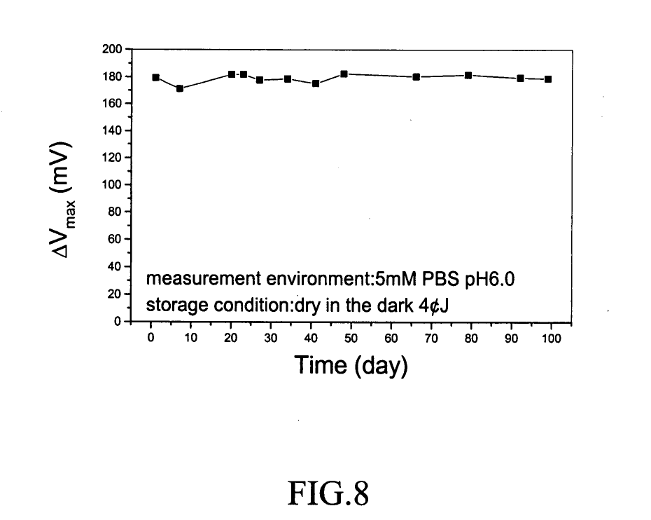

Referring to the FIG. 8, it is the maximum variation of the responsible voltage of the electrical urea biosensor as the time increasing in accordance with the present invention. As shown in the figure, it discusses the stability of the storage status. In the present invention, one hundred disposable urea biosensors formed by the extended tin dioxide/indium tin oxide/glass substrate are prepared to store into the dark box of 4° C. to perform the measurement every 5 to 10 days and to observe the storage time of the formed sensor. According to the experiment, after 99 days, the sensor also can normally work and has no obviously decrement of the maximum response potential.

Hence, the present invention utilizes the ion-sensitive field effect transistor of the separation structure of the extended tin dioxide/indium tin oxide/glass substrate to form the disposable urea biosensor. The structure of the urea biosensor has a best response curve under the work environment of the phosphate solution with 5 mmol and the pH value 6.0. So as the present invention can detect the urea concentration of 0.31 mg/100 ml˜120 mg/100 ml and the sensitivity of the linear portion is 169.1 mvol/p(urea concentration).

The present invention utilizes a non-isolation solid-state ion-sensitive film to use as a sensitive electrode of an ion-sensitive gate field effect transistor by integrating the semiconductor process technology to manufacture a disposable urea biosensor so as the present invention can be mass production and provides with the advantage of the low cost and the easy package so as to reduce the cost of the prior ion-sensitive gate field effect transistor simplify the package. Furthermore, the present invention simultaneously provides with advantages of the simple production, the low cost, easily dry storage, the adjustable sensitive area, and the easy conveyance.

The forgoing description of the embodiments of the invention has been presented for purposes of illustration and description, and is not intended to be exhaustive or to limit the invention to he precise from disclosed. The description was selected to best explain the principles of the invention and practical application of these principles to enable others skilled in the art to best utilize the invention in various embodiments and modifications as are suited to the particular use contemplated. It is intended that the scope of the invention not to be limited by the specification, but be defined by the claim set forth below.

1. An electrical urea biosensor comprising:
a substrate, wherein a conductive layer is formed on a surface of said substrate;
a sensitive film positioned on a surface of said conductive layer of said substrate for using as an ion-sensitive electrode, wherein said sensitive film provides with a sensitive region and a non-sensitive region;
a conductive line extended from said conductive layer for using as an external electrical contact point;
a package encapsulant covering said non-sensitive region of said sensitive film to define a sensitive window at the sensitive region; and
an urea enzyme immobilized within said sensitive window of said sensitive film.

2. The electrical urea biosensor according to claim 1, wherein said substrate is selected from the group of an isolation substrate and a non-isolation substrate.

3. The electrical urea biosensor according to claim 2, wherein said isolation substrate is selected from the group of a silicon substrate, a glass substrate, a ceramics substrate, and a polymer substrate.

4. The electrical urea biosensor according to claim 1, wherein said conductive layer is made of the indium tin oxide (ITO).

5. The electrical urea biosensor according to claim 1, wherein said sensitive film is a non-isolation solid-state ion-sensitive film.

6. The electrical urea biosensor according to claim 1, wherein said sensitive film is made of the tin oxide.

7. The electrical urea biosensor according to claim 1, wherein said sensitive film is formed by the sputtering method.

8. The electrical urea biosensor according to claim 1, wherein said conductive line provides a connection to a high input impedance potentiometer.

9. The electrical urea biosensor according to claim 1, wherein said urea enzyme is immobilized within said sensitive window of said sensitive film by using a enzyme immobilized technology.

10. The electrical urea biosensor according to claim 1, wherein said urea enzyme is composed of urease, which is embedded by a PVA-SbQ encapsulant.

11. A manufacturing method for an electrical urea biosensor, said manufacturing method comprising following steps:
providing a substrate, wherein a conductive layer is formed on a surface of said substrate;
forming a sensitive film on a surface of said conductive layer of said substrate for using as an ion-sensitive electrode, wherein said sensitive film provides with a sensitive region and a non-sensitive region;
forming a conductive line extended from said conductive layer for using as an external electrical contact point;
performing a package step by utilizing a package encapsulant to cover said non-sensitive region of said sensitive film so as to define a sensitive window at the sensitive region; and
utilizing an enzyme immobilized technology to immobilize an urea enzyme within said sensitive window of said sensitive film.

12. The manufacturing method for the electrical urea biosensor according to claim 11, wherein said substrate is selected from the group of an isolation substrate and a non-isolation substrate.

13. The manufacturing method for the electrical urea biosensor according to claim 12, wherein said isolation substrate is selected from the group of a silicon substrate, a glass substrate, a ceramics substrate, and a polymer substrate.

14. The manufacturing method for the electrical urea biosensor according to claim 11, wherein said conductive layer is made of the indium tin oxide (ITO).

15. The manufacturing method for the electrical urea biosensor according to claim 11, wherein said sensitive film is a non-isolation solid-state ion-sensitive film.

16. The manufacturing method for the electrical urea biosensor according to claim 11, wherein said sensitive film is made of the tin oxide.

17. The manufacturing method for the electrical urea biosensor for the electrical urea biosensor according to claim 11, wherein said sensitive film is formed by the sputtering method.

18. The manufacturing method for the electrical urea biosensor according to claim 11, wherein said urea enzyme is immobilized within said sensitive window of said sensitive film by a physics embedding method.

19. The manufacturing method for the electrical urea biosensor according to claim 11, wherein said urea enzyme is composed of urease, which is embedded by a PVA-SbQ encapsulant.
